(19) United States
(12) Patent Application Publication
(10) Pub. No.: US 2025/0017173 A1
(43) Pub. Date: Jan. 16, 2025

(54) Obedience Training Pet Leash and Harness System

(71) Applicant: Christian Delgado, Pepperell, MA (US)

(72) Inventor: Christian Delgado, Pepperell, MA (US)

(21) Appl. No.: 18/902,096

(22) Filed: Sep. 30, 2024

Related U.S. Application Data
(63) Continuation-in-part of application No. 17/540,899, filed on Dec. 2, 2021.

(51) Int. Cl. A01K 27/00

(52) U.S. Cl. CPC A01K 27/004; A01K 27/002

(57) ABSTRACT

An obedience training pet leash and harness system includes a housing. A primary leash is coiled within the housing. The primary leash extends from an opening in the housing with a primary lead that is disposed on a distal end of the primary leash, outside of the housing. A handle is formed on the housing, as well as a clutch trigger. The clutch trigger is configured to restrain the primary leash when the clutch trigger is engaged by the user. The handle has a control center. The control center is designed to control a number of obedience modules. The obedience modules are installed on a harness. The harness is designed to be worn by a pet and is designed to be secured to the primary lead.

### CROSS-REFERENCE TO RELATED APPLICATIONS

This U.S. Continuation-In-Part patent application claims the benefit of U.S. Non-Provisional patent application Ser. No. 17/540,899, filed on Dec. 2, 2021. The above identified patent applications are herein incorporated by reference in their entirety to provide continuity of disclosure.

### BACKGROUND OF THE INVENTION

The present invention relates to an obedience training pet leash. More specifically, the present invention provides a pet leash with enhanced obedience training functionality to assist a pet owner when utilizing a pet leash to restrain his or her pet.

Many people own pets for companionship, for assistance with a disability, or for other similar reasons. Owning a pet is a responsibility, as pets have needs for resources, such as water, food and shelter, in addition to the need for attention and stimulation. Among a pet's many needs, the need for exercise is one that presents a number of unique challenges to the pet's owner.

Generally, a pet owner will secure his or her pet to a leash in order to guide the pet while walking. The leash will also prevent a pet from running away or chasing other pets, people or moving objects. Some pets, however, require obedience training or other conditioning in order to safely and effectively be controlled with a leash. There are several methods of obedience training that may be utilized for training pets. For example, some training methods involve playing sounds, sending low current electrical shocks or locking the leash. Not every training method is effective for every pet.

Therefore, there is a defined need for an improved mechanism for assisting a user in obedience training his or her pet while taking the pet on a walk.

### SUMMARY OF THE INVENTION

In view of the foregoing disadvantages inherent in the known types of pet obedience training systems now present in the prior art, the present invention provides an obedience training pet leash and harness system wherein the same may be utilized for providing convenience for the user when obedience training a pet. The obedience training pet leash and harness system comprises a housing, a primary leash disposed within the housing, wherein the primary leash extends from an opening in the housing, a primary lead disposed on a distal end of the primary leash, the primary lead is disposed outside of the housing, a handle disposed on the housing, a clutch trigger disposed on the housing, the clutch trigger is in operable connection with the leash, wherein the clutch trigger is configured to restrain the primary leash, a control center disposed on the handle, a harness adapted to be worn by a pet, wherein the harness includes one or more obedience training modules, and wherein the one or more obedience training modules is controllable by the control center.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of an embodiment of the obedience training pet leash and harness system.

FIG. 2 shows a close-up view of a control center and top portion of the handle of an embodiment of the obedience training pet leash and harness system.

FIG. 3 shows a perspective view of a harness of an embodiment of the obedience training pet leash and harness system.

FIG. 4 shows an environmental view of a harness of an embodiment of the obedience training pet leash and harness system.

FIGS. 5A-5D show a plurality of perspective views of a harness of an embodiment of the obedience training pet leash and harness system.

FIG. 6 shows a picatinny rail disposed on one of a pair of corresponding female fasteners of an embodiment of the obedience training pet leash and harness system.

FIG. 7 shows a plurality of picatinny rails which includes a light disposed on one of the picatinny rails of an embodiment of the obedience training pet leash and harness system.

### DETAILED DESCRIPTION OF THE INVENTION

Reference is made herein to the attached drawings. Like reference numerals are used throughout the drawings to depict like or similar elements of the obedience training pet leash and harness system 10. The figures are intended for representative purposes only and should not be considered to be limiting in any respect.

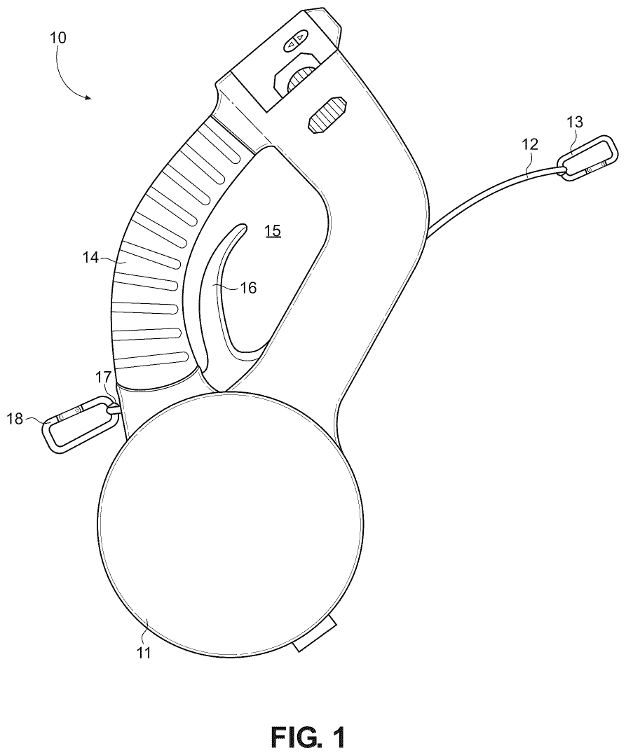

Referring now to FIG. 1, there is shown a side view of an embodiment of the obedience training pet leash and harness system 10.

The obedience training pet leash and harness system 10 comprises a housing 11. The housing 11 is configured to store a primary leash 12 therein. In the illustrated embodiment, the housing 11 is cylindrical, such that the primary leash 12 may be coiled within the housing 11. The primary leash 12 extends outward from an opening defined by the housing. The primary leash 12 comprises a primary lead 13 disposed on a distal end thereof. The primary lead 13 is configured to secure the primary leash 12 to the pet on which the obedience training pet leash 10 is implemented. The primary lead 13 is disposed outside of the housing 11. The primary lead 13 is dimensioned to prevent the primary lead 13 from entering the opening formed by the housing 11. In the illustrated embodiment, the primary lead 13 comprises a carabiner. The carabiner is configured to secure the primary leash 12 to a loop defined on the desired attachment point.

The housing 11 further comprises a handle 14. The handle 14 is configured to assist the user in grasping the obedience pet training leash and harness system 10. In the illustrated embodiment, the handle 14 extends upward from the housing 11, however, in alternate embodiments, the handle 14 may extend from any desired direction, relative to the housing 11. In the illustrated embodiment, the handle 14 is ergonomic, such as to provide enhanced comfort and usability to the user. Specifically, the handle 14 is shaped in an arcuate arrangement, defining a space 15 in which the user may insert his or her hand.

In the illustrated embodiment, the handle 14 defines the space 15 adjacent to the housing 11. In the illustrated embodiment, a clutch trigger 16 is disposed in the space 15 on the housing 11. The clutch trigger 16 is in operable connection with the primary leash 12. The clutch trigger 16 is configured to restrain the primary leash 12 when the clutch trigger 16 is engaged by the user. As such, in the event that the pet attached to the obedience training pet device 10 moves too far away from the housing 11 or attempts to run, the user may engage the clutch trigger 16 to prevent the movement.

Furthermore, in the illustrated embodiment, a secondary leash 17 is disposed on the housing 11. The secondary leash 17 is disposed within the housing 11 and extends outward through a secondary opening defined in the housing 11. The secondary leash, in the illustrated embodiment, comprises a secondary lead 18 disposed thereon. The secondary lead 18 is configured to secure the secondary leash 17 to a desired attachment point. In the illustrated embodiment, the secondary lead 18 comprises a carabiner. The carabiner is configured to secure the secondary leash 17 to a loop defined on the desired attachment point. The secondary leash 17 may be utilized to secure the housing 11 to the user, such as by securing the housing 11 to a waistband or harness worn by the user.

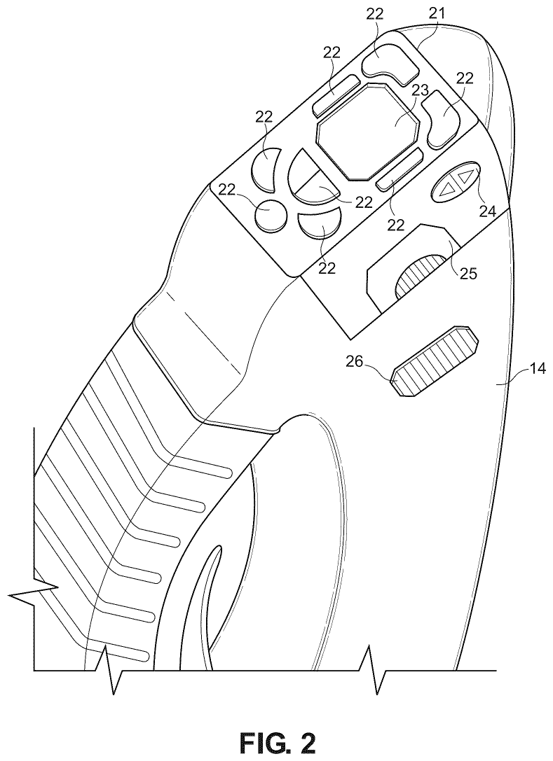

Referring now to FIG. 2, there is shown a close-up view of a control center 21 and top portion of the handle 14 of an embodiment of the obedience training pet leash and harness system 10.

The obedience training pet leash and harness system 10 comprises a control center 21 disposed on the handle 14. The control center 21 is configured to enable the user to control the various functions of the obedience training pet leash and harness system 10. As such, in the illustrated embodiment, the control center 21 comprises a plurality of buttons 22 and a display screen 23.

The plurality of buttons 22 are in operable connection with one or more obedience training modules, the display screen 23 and any other implemented element. As such, when the user engages one or more of the plurality of buttons 22, one or more of the obedience training modules or display screen 23 is actuated. For example, the plurality of buttons 22 may comprise a shock module actuator (not shown), a vibration module actuator (not shown), or an audio module actuator. When the shock module actuator is engaged, the shock module 36 will be engaged. When the vibration module actuator is engaged, the vibration module 38 will be engaged. When the audio module actuator (not shown) is engaged, the audio module 35 will be engaged. In the illustrated embodiment, the plurality of buttons 22 comprises a first set of buttons on a first side of the control center 21 and a second set of buttons on a second side of the control center 21. The first set of buttons correspond to a set of obedience training modules disposed on a first harness, attached to the primary leash.

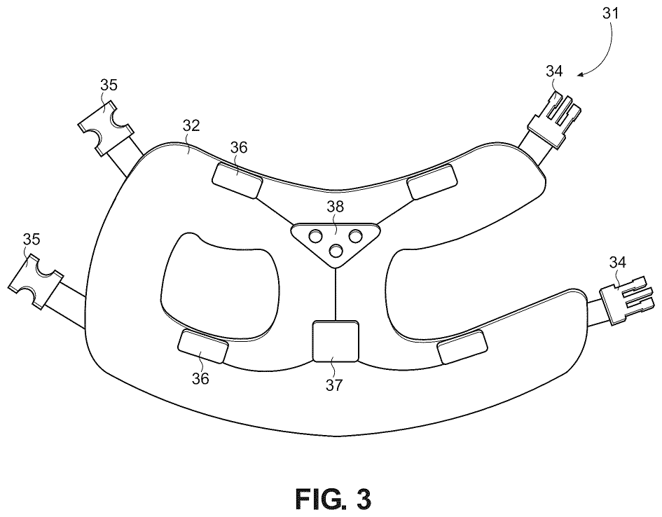

Furthermore, in the illustrated embodiment, the control center 21 further comprises a control dial 24. The control dial 24 is in operable connection with a display 23. As such, the user may manipulate elements of a graphical user interface disposed on the display screen 23 utilizing the control dial 24. Furthermore, in the illustrated embodiment, the control center 21 comprises a detachment actuator 25. The detachment actuator 25 is configured to detach the harness ((31) as shown in FIG. 3) from the obedience training pet leash and harness system 10. Additionally, in the illustrated embodiment, a picatinny rail 26. In the illustrated embodiment the picatinny rail 26 is disposed on a side portion of the handle 14. The picatinny rail 26 is configured to secure one or more desired objects to the obedience training pet leash and harness system 10. For example, the picatinny rail 26 may be utilized to secure a flashlight to the handle 14.

Referring now to FIG. 3, there is shown a perspective view of a harness of an embodiment of the obedience training pet leash and harness system 10.

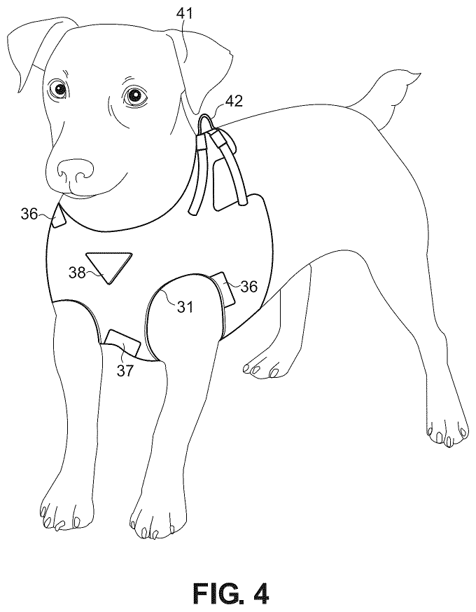

The harness 31 is configured to be worn by a pet ((41), as demonstrated in FIG. 4). In the illustrated embodiment, the harness 31 comprises a harness body 32. The harness body 32 comprises a pair of openings configured to receive the paws of a pet therethrough. The harness body 32 is wrapped around the torso of the pet and secured by connecting a pair of male fasteners 34 to a pair of corresponding female fasteners 35. When wrapped, an opening for the head of the pet and an opening for the rear portion of the pet's torso are formed, thereby securing the harness 31 to the pet, as shown in FIG. 4.

The harness 31 comprises one or more obedience training modules 35, 36, 38. In the illustrated embodiment, the harness 31 comprises an audio module 35, a shock module 36, and a vibration module 38. The audio module 35 is configured to produce audio signals and noises from a speaker (not shown). The shock module 36 is configured to release an electrical shock to the pet. The electrical shock is of a sufficiently low voltage to not be harmful or damaging to the pet. The vibration module 38 is configured to vibrate the harness 31 when engaged. In the illustrated embodiment, the audio module 35, the shock module 36 and the vibration module 38 are in operable connection with a power source 37. The power source 37 is of any suitable orientation for storing electrical power. For example, the power source 37 may be a battery or a rechargeable battery (both not shown) or the like.

Referring now to FIG. 4, there is shown an environmental view of a harness of an embodiment of the obedience training pet leash and harness system 10.

In use, the harness 31 is placed onto the pet 41. The harness 41 comprises a loop 42. The loop 42 is configured to secure the harness 41 to the primary leash of the obedience training pet leash and harness system 10 (shown in FIG. 1). When placed, the plurality of obedience training modules 35, 36, 38 should be placed in positions to maximize their effectiveness. For example, in the illustrated embodiment, the audio module 35 is placed at an edge of the harness 31 closest to the ears of the pet 41, such that the sounds generated by the audio module 35 will be heard by the pet 41 in relatively louder environments. Additionally, in the illustrated embodiment, the shock module 36 is placed in relatively close proximity to the front legs of the pet 41. This may be desirable compared to other positions, as the pet 41 may feel the electrical shock more effectively at this position. Furthermore, in the illustrated embodiment, the vibration module 38 is centrally disposed on a chest portion of the harness 31. As such, the vibrations generated by the vibration module 38 may be felt in a relatively sensitive area of the pet 41. In some embodiments, the vibration module 38 may be disposed on other areas of the harness such as the back portion of the harness.

In some embodiments, the obedience training pet leash and harness system 10 comprises a perimeter mode. The perimeter mode enables the user to define a perimeter, around the obedience training pet leash, in which one or more of the obedience training modules 35, 36, 38 will be actuated when the harness 31 is detected to surpass the defined perimeter. Detection of the perimeter breach may be accomplished by any suitable means, such as by radio frequency (RF) or by a wireless network connection (WiFi) (both not shown). Alternatively, the perimeter functionality may be defined utilizing an electric fence (not shown). In other embodiments, the control center 21 may provide different modes for the perimeter mode. For example, a dog walk mode, for situations where the pet 41 is on the leash, may be defined where the audio module 35 is actuated at a distance of approximately 1.5 yards, the vibration module 38 is actuated at a distance of approximately 2.5 yards, and the shock module 36 is actuated at a distance of approximately 3.5 yards or the like. Additionally, a dog park mode, for situations where the pet 41 is off the leash, may be defined where the audio module 35 is actuated at a distance of approximately 50 yards, the vibration module 38 is actuated at a distance of approximately 51 yards, and the shock module 36 is actuated at a distance of approximately 52.5 yards.

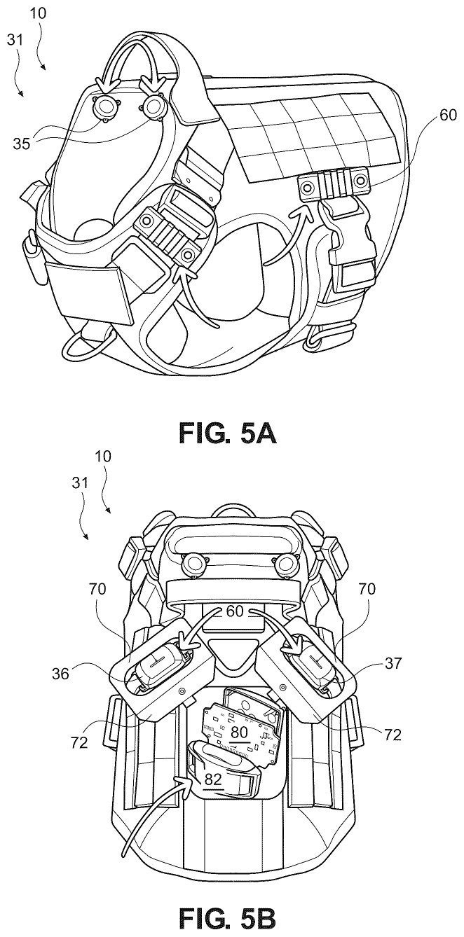

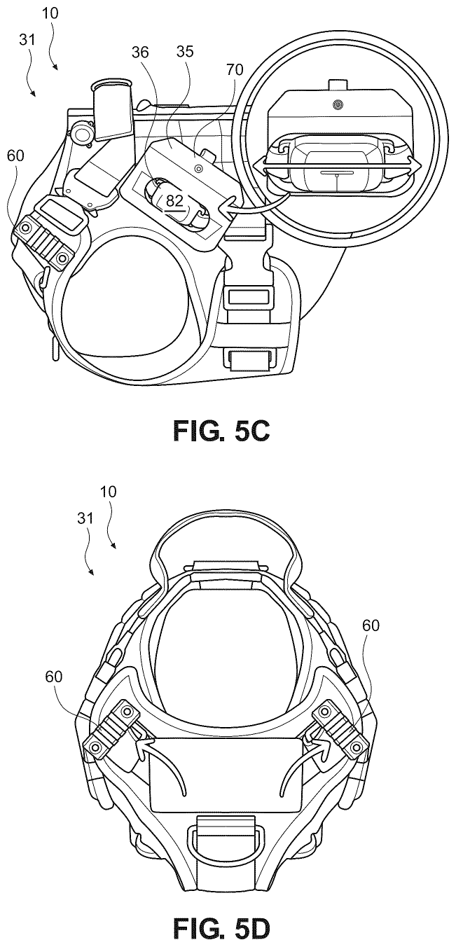

FIGS. 5A-5D show a plurality of perspective views of the harness 31 of an embodiment of the obedience training pet leash and harness system 10.

The harness 31 in FIG. 5A may include a plurality of the audio modules 35 and a plurality of picatinny rails 60.

The audio actuators 50 may be woven into the harness 31 or the like. The picatinny rails 60 may be disposed on each side of the harness 31 or the like.

The harness 31 in FIG. 5B may include a plurality of pouch housing 70 and a plurality of printed circuit board or PCB boards 80.

The pouch housing 70 may include a hook and loop fastener or VELCRO® fastener 72 disposed on a top edge of the harness 31 to each hold the shock module (FIG. 4, 36) and/or the vibration module (FIG. 4, 37) or the like. The PCB boards 80 may each be encased in a housing 82 made of plastic, metal, or the like.

The harness 31 in FIG. 5C may include the pouch housing 70 and the shock module (FIG. 4, 36) and/or the vibration module (FIG. 4, 37) or the like that is relatively large enough to allow the shock module 36 and/or the vibration module 37 or the like to move within the pouch housing 70 to accommodate dogs with different sized anatomical structure.

The harness 31 in FIG. 5D may include the picatinny rails 60 disposed on each side of the harness 31.

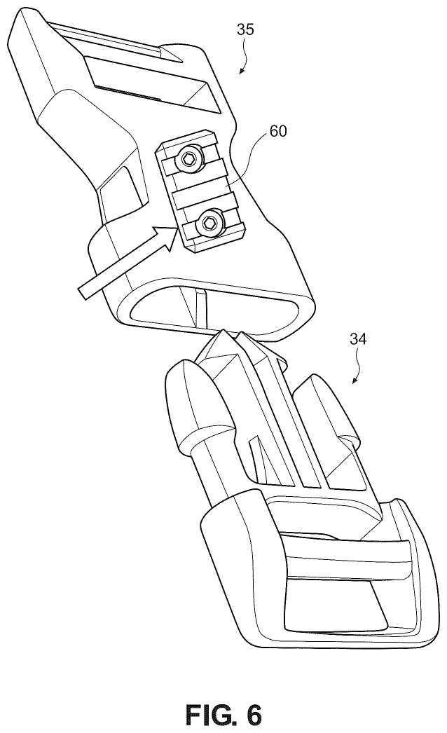

FIG. 6 shows a picatinny rail 60 disposed on one of a pair of corresponding female fasteners 35 of an embodiment of the obedience training pet leash and harness system 10.

The one of a pair of corresponding female fasteners 35 may include a pair of the picatinny rails 60 disposed on top of the one of a pair of corresponding female fasteners 35.

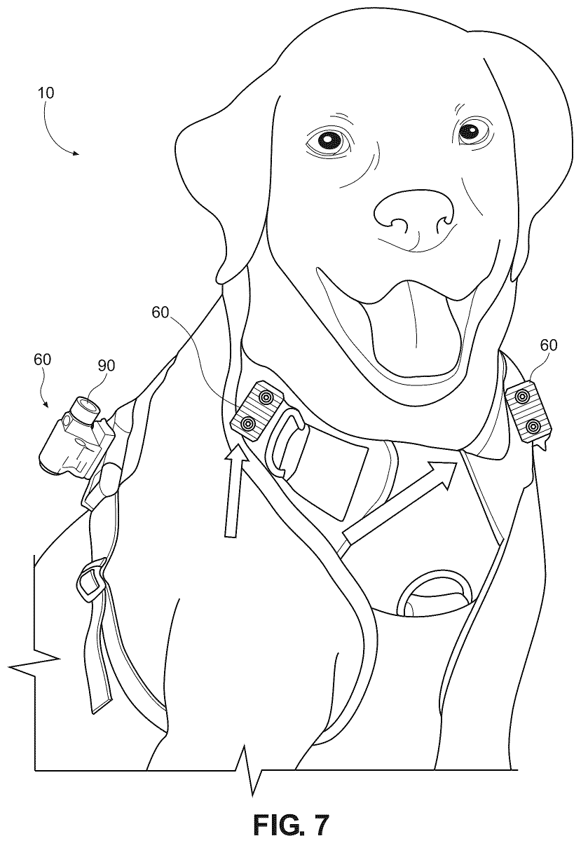

FIG. 7 shows a plurality of picatinny rails 60 which includes a light 90 disposed on one of the picatinny rails 60 of an embodiment of the obedience training pet leash and harness system 10.

The light 90 may be disposed on a top side of one of the picatinny rails 60 or the like.

Use of the obedience training pet leash and harness system 10 is fairly straightforward. The harness 31 of the obedience training pet leash and harness system 10 is an e-collar used in a non-traditional way to produce results over time and over distance. The harness 31 of the obedience training pet leash and harness system 10 has come a long way from the shock collar training of yesteryear. Old shock collars used electrical pulses to send shock waves to your dogs, while the harness 31 uses electronic stimulation (instead of static shock) to stimulate the nerves in a dog's neck muscles. At relatively low intensities, the dog feels as if it's being tapped repeatedly on the shoulder by the harness 31.

Tapping a dog's shoulder may be an effective way to get their attention due to several reasons. Dogs have relatively highly developed senses, including touch. Their skin is relatively sensitive, and they may perceive even subtle physical cues. When you tap a dog's shoulder, it provides a tactile sensation that stands out from other stimuli that may relatively quickly grab their attention.

Dogs communicate with each other through body language, including gentle nudges or touches. Tapping on the dog's shoulder mimics this natural communication and is a relatively non-threatening way to convey information to the dog.

Shoulder tapping may redirect a dog's focus from distractions or undesired behaviors. For example, if a dog is about to jump on a visitor, a tap on the dog's shoulder may interrupt the behavior and redirect their attention to you.

Consistent shoulder taps, followed by positive reinforcement (such as treats or praise), create an association. Dogs learn that when they feel the shoulder tap, good things happen and over time, they become conditioned to respond positively. Remember that individual dogs may react differently, so always observe an individual dog's response and adjust training techniques accordingly, while exercising patience and consistency are also relatively very important.

The following overall method may set-up and use a parameter setting for distance-based activation and manual control of the obedience training pet leash and harness system 10 in a user-friendly manner.

The overall method includes activating a manual button input for instant commands, activating a power button to turn on a remote control, selecting a receiver between using a switch or a button to choose a channel for all receivers, activating a function by pressing one or more clearly labeled designated buttons for audio, vibrate, or shock functions, setting distance parameters manually, entering a setting mode by pressing and holding a specific combination of buttons to enter a setting mode, adjusting an activating distance by approximately 0.5 yards, holding the activation button for rapid adjustment, a plurality of presetting distances, and for quick setting specific buttons that may jump the setting distance to preset values (e.g., approximately 10 yards, approximately 50 yards, and approximately 100 yards), confirming the setting distance by activating the confirm button to save the setting, using a plurality of preset settings such as selecting a preset mode, switching to the preset mode via a toggle or by entering a menu, choosing the preset selection from a plurality of predetermined distance presets by scrolling through a scrolling menu or a plurality of direct selection buttons 22, and applying the preset choice to apply the preset distance.

The overall method ensures that the user may relatively easily operate the obedience training pet leash and harness system 10, with clear instructions and feedback for each action, making it accessible for operators of all skill levels.

In other embodiments, the obedience training pet leash and harness system 10 is linked to a mobile phone application (not shown). The mobile phone application is configured to supplement the functionality while utilizing the functionality of the existing components. The mobile phone application may be utilized to control the functionality of the control center instead of the plurality of buttons 22. Furthermore, the mobile phone application may be utilized to measure and display activity levels and to record the times and durations of certain activities associated with the obedience training pet leash and harness system 10, such as dog walking time or outside time. Furthermore, the mobile phone application may be utilized for advertisements and services. In one embodiment, the user may be able to input the breed and weight of their pet 41 in order to receive activity recommendations and health advice from participating veterinary professionals.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An obedience training pet leash and harness system, comprising:
a housing;
a primary leash disposed within the housing;
wherein the primary leash extends from an opening in the housing;
a primary lead disposed on a distal end of the primary leash, the primary lead disposed is outside of the housing;
a handle disposed on the housing;
a clutch trigger disposed on the housing, the clutch trigger is in operable connection with the leash;
wherein the clutch trigger is configured to restrain the primary leash;
a control center disposed on the handle;
a harness configured to be worn by a pet;
wherein the harness includes one or more obedience training modules; and
wherein the one or more obedience training modules is controllable by the control center.

2. The obedience training pet leash and harness system of claim 1, wherein the control center includes a plurality of buttons and a display screen.

3. The obedience training pet leash and harness system of claim 1, wherein the primary lead includes a carabiner.

4. The obedience training pet leash and harness system of claim 1, wherein the primary leash is detachable from the housing.

5. The obedience training pet leash and harness system of claim 1, further comprising a secondary leash with a secondary lead disposed on an opposing end of the housing from the primary lead.

6. The obedience training pet leash and harness system of claim 5, wherein the secondary leash is detachable from the housing.

7. The obedience training pet leash and harness system of claim 6, wherein the secondary lead includes a carabiner.

8. The obedience training pet leash and harness system of claim 1, wherein the handle is ergonomic.

9. The obedience training pet leash and harness system of claim 1, wherein the harness includes a shock module and the control center having a shock module actuator configured to engage the shock module.

10. The obedience training pet leash and harness system of claim 1, wherein the harness includes a vibration module and the control center includes a vibration module actuator configured to engage the vibration module.

11. The obedience training pet leash and harness system of claim 1, wherein the harness includes an audio module and the control center includes an audio module actuator configured to engage the audio module.

12. The obedience training pet leash and harness system of claim 1, further comprising a perimeter mode, wherein one or more of the obedience training modules is actuated when a distance between the obedience training pet leash and the harness exceeds a specified amount.

13. The obedience training pet leash and harness system of claim 1, wherein the control center is in operable connection with and controllable via a mobile phone application.

14. The obedience training pet leash and harness system of claim 13, wherein the mobile phone application is configured to measure distances and times associated with the pet leash and harness system.

15. The obedience training pet leash and harness system of claim 14, wherein the mobile phone application is configured to receive a set of input information in the form of the breed and weight of a pet utilizing the obedience training pet leash and harness system and to make recommendations based off the set of input information.

16. The obedience training pet leash and harness system of claim 15, wherein the harness includes a plurality of picatinny rails.

17. The obedience training pet leash and harness system of claim 16, wherein the picatinny rails are disposed on each side of the harness.

18. The obedience training pet leash and harness system of claim 17, wherein the harness includes a plurality of pouch housing and a plurality of printed circuit boards.

19. The obedience training pet leash and harness system of claim 18, wherein the pouch housing includes a hook and loop fastener disposed on a top edge of the harness to each hold the shock module and the vibration module.

20. The obedience training pet leash and harness system of claim 19, wherein the harness include the pouch housing and the shock module and the vibration module that is large enough to allow the shock module and the vibration module to move within the pouch housing to accommodate dogs with different sized anatomical structure.

21. The obedience training pet leash and harness system of claim 18, wherein the printed circuit boards are each be encased in a housing.

22. The obedience training pet leash and harness system of claim 21, wherein the housing is made of metal or plastic.

23. The obedience training pet leash and harness system of claim 16, wherein the picatinny rails are disposed on each side of the harness.

24. The obedience training pet leash and harness system of claim 16, wherein the picatinny rails are disposed on one of a pair of corresponding female fasteners.

25. The obedience training pet leash and harness system of claim 24, wherein the one of a pair of corresponding female fasteners include a pair of the picatinny rails disposed on top of the one of a pair of corresponding female fasteners.

26. The obedience training pet leash and harness system of claim 25, wherein one of the picatinny rails includes a light disposed on a top side of the one of the picatinny rails.
